(19) United States
(12) Patent Application Publication
(10) Pub. No.: US 2005/0128295 A1
(43) Pub. Date: Jun. 16, 2005

(54) Wireless security video system with a pre-alarm buffer

(75) Inventor: Kenneth L. Addy, Massapequa, NY (US)

Correspondence Address: HONEYWELL INTERNATIONAL INC., 101 COLUMBIA ROAD, P O BOX 2245, MORRISTOWN, NJ, 07962-2245, US

(73) Assignee: Honeywell International, Inc., Morristown, NJ (US)

(21) Appl. No.: 10/733,727

(22) Filed: Dec. 11, 2003

(51) Int. Cl. H04N 7/18

(52) U.S. Cl. 348/153; 348/143

(57) ABSTRACT

Security systems are disclosed in which intrusion security sensors provided on the perimeter of a protected space immediately activate a plurality of wireless RF, battery operated, low current drain security video cameras elsewhere in the protected space to enable pre-alarm video recording by the security video cameras. Each security video cameras is capable of operating in a standby inactive video mode, providing a low electrical power consumption, or in an active video recording mode. Each security sensor includes an RF transmitter for transmitting an RF security/alarm event message indicating detection of a security/alarm event. Upon detection of an alarm event by a security sensor, the security sensor transmits an RF security/alarm event message which causes the security system video cameras to awaken from the standby inactive video mode into the active video recording mode.

### BACKGROUND OF THE INVENTION

1. Field of the Invention

The present invention relates generally to wireless RF security video systems and cameras having a pre-alarm buffer, and more particularly pertains to security systems and methods utilizing a plurality of wireless RF, battery operated, low current drain, low cost security video cameras, each having a relatively small pre-alarm buffer. The buffer is capable of storing a relatively small number of image frames taken over a relatively short period of time, with those constraints being imposed because of the limited power storage provided by the battery power supply.

2. Discussion of the Prior Art

Wireless video cameras are frequently used in security system installations to record and transmit alarm/security events for both alarm verification, before the police are dispatched, and for potential evidence in cases of criminal activity.

AC powered (non-battery operated) security video cameras can be maintained in a constantly-on state to simply continuously write video frames into a memory which records the video data. The memory could be a hard drive memory that stores video images over a relatively long period of time (e.g. several months) or a circular buffer memory that records and stores the video frames for a shorter given period of time, after which the video frames are written over with new video data in a circular fashion. When a security sensor, such as an intrusion detector or a motion detector, associated with a particular video camera detects an alarm or security event, the buffer is stopped at a certain point in order to retain in memory the record of pre-alarm and post-alarm activities and events.

Wireless, battery powered security video cameras cannot be maintained in a constantly-on state to continuously write to a video memory because of the limited power consumption constraint provided by the battery power supply.

### SUMMARY OF THE INVENTION

The present invention pertains to security systems and methods in which intrusion security sensors provided on the perimeter of a protected space immediately activate a plurality of wireless RF, battery operated, low current drain security video cameras elsewhere in the protected space to enable pre-alarm video recording by the security video cameras.

Each security video camera is capable of operating in a standby inactive video mode, providing a low electrical power consumption, or in an active video recording mode. Each security sensor includes an RF transmitter for transmitting an RF security/alarm event message indicating detection of a security/alarm event. Upon detection of an alarm event by a security sensor, the security sensor transmits an RF security/alarm event message which causes the security system video cameras to awaken from the standby inactive video mode into the active video recording mode.

### BRIEF DESCRIPTION OF THE DRAWINGS

The foregoing objects and advantages of the present invention for a wireless video system with a pre-alarm buffer may be more readily understood by one skilled in the art with reference being had to the following detailed description of several embodiments thereof, taken in conjunction with the accompanying drawings in which:

FIG. 1 illustrates a security system pursuant to the present invention having a plurality of wireless RF, battery operated, low current drain security video cameras.

### DETAILED DESCRIPTION OF THE INVENTION

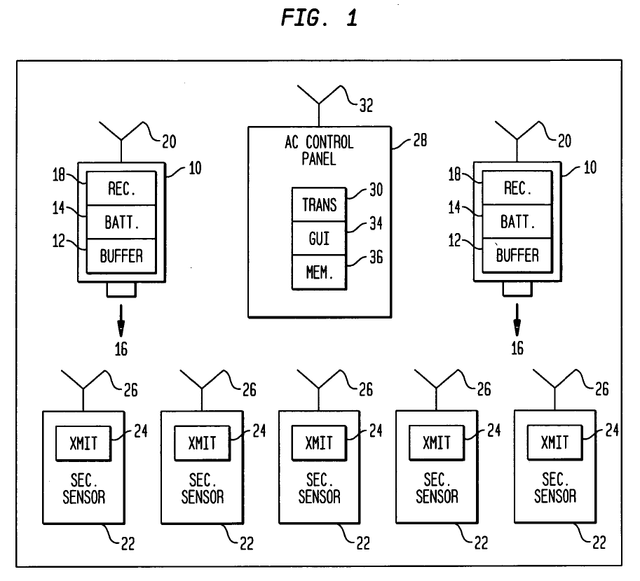

FIG. 1 illustrates a security system for a protected space or premises pursuant to the teachings of the present invention having a plurality of wireless RF, battery operated, low current drain, low cost security video cameras 10. In one embodiment, each security video camera is provided with a relatively small pre-alarm buffer memory 12 capable of storing a relatively small number of image frames (e.g. ten image frames) taken over a relatively short period of time (e.g. ten seconds). Those constraints are imposed because of the limited power storage available from the battery power supply 14, although it is expected that as technology develops further, the exemplary number of image frames and time period will improve further. Each security video cameras 10 is positioned to take video frames of an observed area 16, and has a wireless RF receiver 18 and antenna 20 for receiving RF messages.

The security system includes a plurality of security sensors 22, such as intrusion sensors or motion/occupancy sensors, for detecting a security/alarm event. Each security sensor has an RF transmitter 24 and antenna 26 for transmitting an RF security/alarm event message when the sensor detects a security/alarm event.

The security system also typically includes a security system control panel 28 that includes an RF transceiver 30 and antenna 32 for transmitting and receiving RF messages, and a display 34 such as a GUI (graphical user interface) which allows a person to review the status of and control the operation of the security system, such as to place the security system in an armed state or an unarmed state. The security system control panel receives each RF security/alarm event message transmitted by a security sensor 22.

Each security video camera 10 is capable of operating in a standby inactive video mode, providing a low electrical current consumption, or operating in an active video recording mode that consumes a greater amount of electrical power. Because of the limited power consumption constraint provided by the battery power supply 14, each security video camera 10 is not maintained in a constantly-on state and is operated only upon detection of a security/alarm event. Moreover, in different embodiments of the present invention, the security system control panel 28 can control operation of the security video cameras 10, by enabling the security video cameras (to be switched to the active video recording mode by an RF security/alarm event message from a security sensor 22) when the security system is in an armed state, and disabling the security video cameras (from being switched to the active video recording mode by an RF security/alarm event message from a security sensor 22) when the security system is in an unarmed state. Moreover, in alternative embodiments, the security system control panel 28 can directly control operation of the security video cameras 10 by switching the security video cameras to the active video recording mode when the security system control panel receives an RF security/alarm event message from a security sensor 22 and the security system is in an armed state.

The security system and security video cameras can operate in any one of several different modes of operation.

In a first mode of operation, the detection of a security/alarm event by a security sensor 22 of the security system causes the security sensor to transmit an RF security/alarm event message to all of the security system video cameras 10 to awaken them from the standby inactive video mode into the active video recording mode, typically for a predetermined period of time. In this mode of operation, the security video cameras are always switched from the standby inactive video mode, providing a low electrical current consumption, into the active video recording mode, that consumes a greater amount of electrical power, by an RF security/alarm event message from a security sensor. If a security sensor associated with a particular security video camera detects a security/alarm event, the video buffer of that camera is stopped in the same way as in the AC wired security video camera. For example, a perimeter intrusion sensor on a door or window detects a security/alarm event and sends a wireless RF security/alarm event message that is received by all of the security video cameras of the security system, or a particular sector of the security system, each of which then begins recording video images into a video memory. The initiating message from the first security sensor detecting a security/alarm event is also received by the security system control panel for processing, as is normal in existing wireless security products.

In a variation of this mode of operation, the security system control panel 28 can enable and disable operation of the security video cameras 10, enabling the security video cameras to be switched to the active video recording mode, by an RF security/alarm event message from a security sensor 22, when the security system is in an armed state, and disabling the security video cameras from being switched to the active video recording mode, by an RF security/alarm event message from a security sensor 22, when the security system is in a disarmed state.

In this mode of operation, when the security system control panel is armed it transmits an RF enable message to the security video cameras to place them in an enabled state, in which an RF security/alarm event message from a security sensor will activate the security video cameras. And when the security the security system control panel is disarmed it transmits an RF disable message to the security video cameras to place them in a disabled state, in which an RF security/alarm event message from a security sensor will not activate the security video cameras.

In an alternative mode of operation of the subject invention, the security system control panel 28 can directly control operation of the security video cameras 10 by switching the security video cameras to the active video recording mode when the security system control panel receives an RF security/alarm event message from a security sensor 22. In this mode of operation, a perimeter intrusion sensor detecting a security/alarm event sends a wireless RF security/alarm event message that is received by the security system control panel, which then sends a wireless RF awaken message to all of the security video cameras of the security system, or a sector of the security system, each of which then begins recording video images into a video memory.

This embodiment of the present invention provides an advantage in that the security system control panel can send the wireless RF awaken transmission to all of the security video cameras only if the security system control panel is in an armed state, and not send the wireless RF awaken transmission to all of the security video cameras if the security system control panel is in a disarmed state.

The low current receiver of the security video camera can be a continuously-on superregenerative type of receiver or an equivalent low current design receiver, or could be a synchronized, paging type of receiver.

In different embodiments of the present invention, the video storage memory can be local to the camera as a local buffer memory 12, or can be remote from the camera and upon activation, the wireless video security camera transmits video data to the remote video storage memory 36 which could be AC operated and have a much larger storage capacity.

While several embodiments and variations of the present invention for a wireless security video system with a pre-alarm buffer are described in detail herein, it should be apparent that the disclosure and teachings of the present invention will suggest many alternative designs to those skilled in the art.

1. A security system comprising:
a plurality of battery operated security video cameras, each having an RF receiver and operating in a standby inactive video mode, providing a low electrical power consumption, or in an active video recording mode that consumes a greater amount of electrical power;
a plurality of security sensors for detecting a security/alarm event, each having an RF transmitter for transmitting an RF security/alarm event message indicating detection of a security/alarm event;
wherein an alarm event detected by a security sensor of the security system causes the security sensor to transmit an RF security/alarm event message which causes the security system video cameras to awaken from the standby inactive video mode into the active video recording mode.

2. The security system of claim 1, wherein each security video camera awakens from the standby inactive video mode into the active video recording mode for a predetermined period of time.

3. The security system of claim 1, wherein each security video camera is awakened from the standby inactive video mode into the active video recording mode by a security/alarm event message received from a security sensor.

4. The security system of claim 3, wherein each security video camera is always switched from the standby inactive video mode to the active video recording mode by an RF security/alarm event message from a security sensor.

5. The security system of claim 3, wherein the security system includes a security system control panel which has an armed state in which the security system is armed and a disarmed state in which the security system is disarmed, and the security system control panel sends an RF enable message, enabling each security video camera to be awakened from the standby inactive video mode into the active video recording mode by a security/alarm event message received from a security sensor, if the security system control panel is in an armed state.

6. The security system of claim 3, wherein the security system includes a security system control panel which has an armed state in which the security system is armed and a disarmed state in which the security system is disarmed, and the security system control panel sends an RF disable message, disabling each security video camera from being awakened from the standby inactive video mode into the active video recording mode by a security/alarm event message received from a security sensor, if the security system control panel is in a disarmed state.

7. The security system of claim 1, wherein the security system includes a security system control panel which receives the RF security/alarm event message, and the security system control panel sends an RF awaken message to the security video cameras to cause the security system video cameras to awaken from the standby inactive video mode into the active video recording mode.

8. The security system of claim 7, wherein the security system control panel has an armed state in which the security system is armed and a disarmed state in which the security system is disarmed, and the security system control panel sends an RF awaken message to the security video cameras if the security system control panel is in an armed state and does not send the RF awaken message to the security video cameras if the security system control panel is in a disarmed state.

9. The security system of claim 1, wherein each security video camera includes a video storage buffer memory local to the security video camera.

10. The security system of claim 1, wherein the security system includes a remote video storage memory remote to each security video camera, and upon activation each video security camera transmits video data to the remote video storage memory.

11. A method of operating a security system comprising:
operating a plurality of battery operated security video cameras, each having an RF receiver, in either a standby inactive video mode, providing a low electrical power consumption, or in an active video recording mode that consumes a greater amount of electrical power;
transmitting, by each of a plurality of security sensors for detecting a security/alarm event, an RF security/alarm event message upon detection of a security/alarm event;
upon transmission of an RF security/alarm event message, awakening the security system video cameras from the standby inactive video mode into the active video recording mode.

12. The method of claim 11, including awakening each security video camera from the standby inactive video mode into the active video recording mode for a predetermined period of time.

13. The method of claim 11, including awakening each security video camera from the standby inactive video mode into the active video recording mode upon each security video camera receiving a security/alarm event message from a security sensor.

14. The method of claim 13, including always switching each security video camera from the standby inactive video mode to the active video recording mode upon receiving an RF security/alarm event message from a security sensor.

15. The method of claim 13, wherein the security system includes a security system control panel which has an armed state in which the security system is armed and a disarmed state in which the security system is disarmed, and the security system control panel sending an RF enable message, enabling each security video camera to be awakened from the standby inactive video mode into the active video recording mode by a security/alarm event message received from a security sensor, if the security system control panel is in an armed state.

16. The method of claim 13, wherein the security system includes a security system control panel which has an armed state in which the security system is armed and a disarmed state in which the security system is disarmed, and the security system control panel sending an RF disable message, disabling each security video camera from being awakened from the standby inactive video mode into the active video recording mode by a security/alarm event message received from a security sensor, if the security system control panel is in a disarmed state.

17. The method of claim 11, wherein the security system includes a security system control panel which upon receiving the RF security/alarm event message, sends an RF awaken message to the security video cameras to cause the security system video cameras to awaken from the standby inactive video mode into the active video recording mode.

18. The method of claim 17, wherein the security system control panel has an armed state in which the security system is armed and a disarmed state in which the security system is disarmed, and the security system control panel sending an RF awaken message to the security video cameras if the security system control panel is in an armed state and not sending the RF awaken message to the security video cameras if the security system control panel is in a disarmed state.

19. The method of claim 11, each security video camera storing video data in a video storage buffer memory local to the security video camera.

20. The method of claim 11, each security video camera, upon activation, transmitting video data to a remote video storage memory remote to the security video camera.
